(19) United States
(12) Patent Application Publication
(10) Pub. No.: US 2004/0204969 A1
(43) Pub. Date: Oct. 14, 2004

(54) System and method for automatic tracking of cargo

(76) Inventor: Po-Hsuan Wu, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/683,054

(22) Filed: Oct. 9, 2003

(30) Foreign Application Priority Data
Apr. 11, 2003 (TW) 92108305

(51) Int. Cl. G06F 17/60

(52) U.S. Cl. 705/6

(57) ABSTRACT

An automatic cargo tracking system and method includes: a database server (10), a plurality of client computers (16), and an application server (12) linked to the client computers via a network. The application server includes a basic information maintenance module (122) for generating export files and cargo tracking records; a tracking module (123) for receiving information on cargo tracking and abnormality messages sent by the client computers; an alert module (125) for generating alerts messages; and a path management module (126) for receiving abnormality messages from the client computers and/or alert messages sent by the alert module of the application server, determining whether to switch current shipping paths based on feedback messages received from the client computers of corresponding forwarders, and for selecting new optimal paths to maintain a delivery date. A related method is also disclosed.

### BACKGROUND OF THE INVENTION

1. Field of the Invention

The present invention relates to automatic cargo tracking systems and methods, and particularly to an automatic cargo tracking system and method that provides switching of current shipping paths when deemed necessary.

2. Background of the invention

Against the background of globalization of domestic economies, the rapid development of the logistics industry has brought profound changes to the global supply chain of enterprises that deal in commodities. Sophisticated IT (Information Technology) logistic systems are becoming an essential element for the management and operation of enterprise logistics. These systems increase operating efficiency, reduce costs, and improve customer service.

New system configurations have emerged from recent developments in the logistics industry. For example, bar code technology and EDI (Electronic Data Interchange) technology are used to obtain information on shipping statuses of cargo in real time, thereby improving the level of service of logistics transportation organizations. Taiwan Published Patent No. 507,150 issued on Oct. 21, 2002 and entitled “System for tracking information on cargo statuses” is exemplary in this regard. The system disclosed in this patent is implemented for tracking and querying information on cargo statuses, and for sending alert messages by email when cargo is delayed. However, the system does not provide measures against delay, even though delay is endemic due to factors such as bad weather and human error. The system unable to provide for avoidance or amelioration of delay.

### SUMMARY OF THE INVENTION

Accordingly, an object of the present invention is to provide an automatic cargo tracking system and method which enables switching of current shipping paths to avoid or reduce any delay in delivery of cargo.

To achieve the above-mentioned object, an automatic cargo tracking system of the present invention comprises: a database server, a plurality of client computers, an application server, and a network connecting the application server to the client computers. The database server comprises: a basic information database for storing information on cargo and information on forwarders; a shipping path database for storing information on shipping paths, the information on shipping paths comprising names of ports that a cargo passes through, a standard arrival time and an estimated arrival time for each of said ports, and a standard departure time and an estimated departure time for each of said ports; and an on way cargo database for storing cargo tracking records, wherein the cargo tracking record comprises columns for: packing number, information on shipping path, actual arrival time for each of ports that a cargo passes through, actual departure time for each of said ports, system status, shipping status, current position, and proof of delivery. The application server receives information on cargo tracking and abnormality messages from the client computers via the network. The application server comprises: a tracking module for obtaining an arrival time and a departure time of an original port, information on a shipping path from the shipping path database, and information on cargo tracking and a proof of delivery from a respective one of the client computers; an alert module for comparing an actual time with a corresponding estimated time in a cargo tracking record, and for generating an alert message when the actual time is later than the estimated time; and a path management module for determining whether to switch a particular shipping path based on any alert message or any abnormality message, for selecting a new optimal shipping path where appropriate, and for switching the shipping path to maintain the delivery date.

Further, the present invention provides an automatic cargo tracking method, the method comprising the steps of: (a) obtaining data on export cargo, and generating corresponding export files and a cargo tracking record; (b) comparing an actual time with an estimated time of a current port in a particular cargo tracking record, and generating an alert message when the actual time is later than the estimated time; (c) receiving the alert message, determining whether to switch a current shipping path, and switching the current shipping path if appropriate; (d) receiving information on cargo tracking from relevant client computers, and storing the information on cargo tracking in the cargo tracking record; (e) determining whether to continue cargo tracking by accessing the cargo tracking record, and returning to step (b) if one or more ports still do not have data; and (f) receiving a proof of delivery if all ports have data.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of an application environment of an automatic cargo tracking system in accordance with a preferred embodiment of the present invention;

FIG. 2 is a block diagram of software infrastructure of the automatic cargo tracking system of FIG. 1, but showing only one client computer thereof;

FIG. 3 is a schematic diagram of sub-modules of a path management module of an application server of the automatic cargo tracking system shown in FIG. 2;

FIG. 4 is a flowchart of operation of the automatic cargo tracking system of FIG. 1; and

FIG. 5 is a flowchart of details of one step of FIG. 4, namely determining whether to switch the current shipping path.

### DETAILED DESCRIPTION OF THE INVENTION

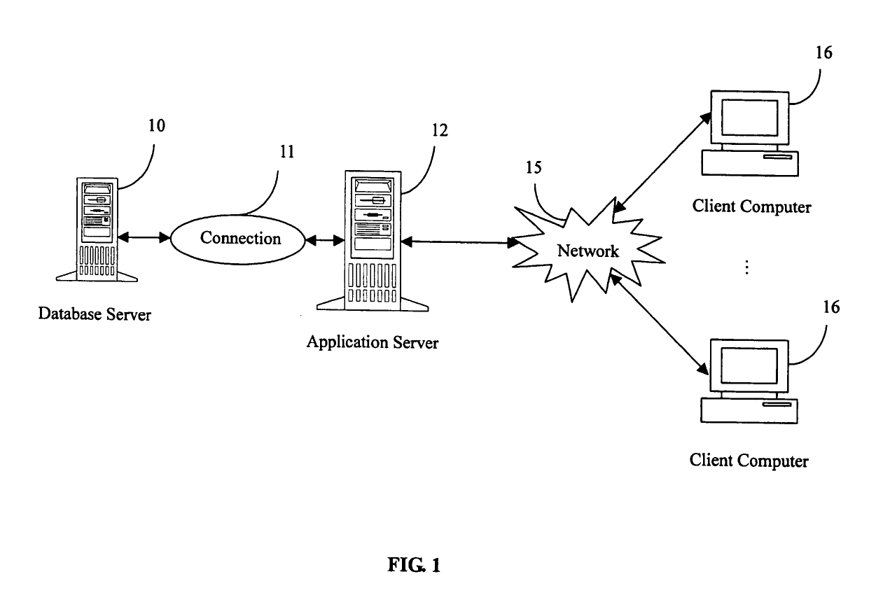

FIG. 1 is a schematic diagram of an application environment of an automatic cargo tracking system in accordance with the preferred embodiment of the present invention. The automatic cargo tracking system comprises a database server 10, an application server 12, a plurality of client computers 16, a connection 11 connecting the database server 10 and the application server 12, and a network 15 connecting the application server 12 and the client computers 16. The connection 11 is connectivity such as ODBC (Open Database Connectivity) or JDBC (Java Database Connectivity). The network 15 can be an intranet or the Internet, through which the application server 12 can receive information on cargo tracking and abnormality messages from the client computers 16, and through which users can query up-to-date cargo tracking records to obtain required information on cargo tracking. The information on cargo tracking comprises an actual arrival time and an actual departure time for each port through which a cargo has passed, a system status, a shipping status, and a current position of the cargo. The system status indicates a status of whether and how the automatic cargo tracking system is dealing with the cargo; and may for example be “Not Started,” “In Process,” “Delivered,” or “Closed.” The shipping status provides details on cargo whose system statuses are “In Process;” and may for example be “waiting” or “on way.” “Waiting” means that a cargo has arrived at a port, and is waiting for departure from the port. “On way” means that a cargo has left a port, and is on the way to a next port.

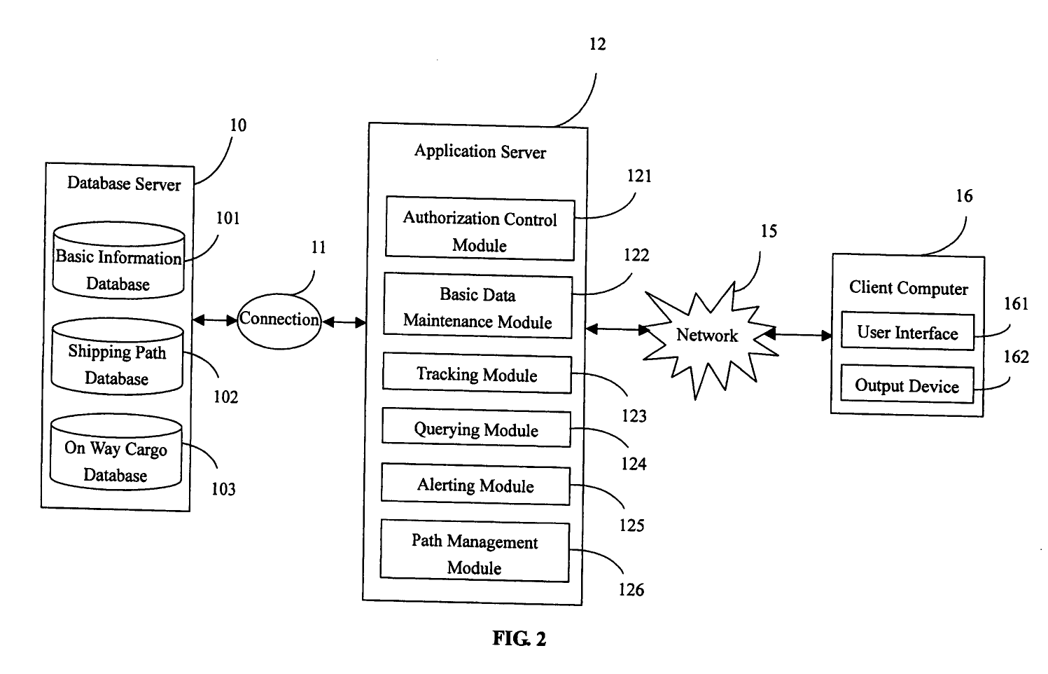

FIG. 2 is a bock diagram of software infrastructure of the automatic cargo tracking system of FIG. 1, but showing only one client computer 16. The database server 10 comprises a basic information database 101 for storing information on cargo and forwarders; a shipping path database 102 for storing information on shipping paths; and an on way cargo database 103 for storing cargo tracking records, export files, abnormality records and a temporary datasheet. The information on shipping paths comprises names of ports that a cargo passes through, a standard arrival time and an estimated arrival time for each of said ports, and a standard departure time and an estimated departure time for each of said ports. The cargo tracking record comprises columns for: packing number, information on shipping path, actual arrival time for each of ports that a cargo passes through, actual departure time for each of said ports, system status, shipping status, current position, and proof of delivery. The temporary datasheet is used for temporarily storing information on cargo tracking. The client computer 16 comprises a user interface 161 and an output device 162. The user interface 161 provides an interactive interface for carrying out operations such as inputting basic information and data on cargo tracking from forwarders, for receiving abnormality messages from forwarders, and for adding, modifying, deleting or searching basic information. The output device 161 displays information including cargo tracking records, export files and basic information on cargo and forwarders. Each abnormality message reports a time delay resulting from causes such as bad weather or human error.

The application server 12 comprises an authorization control module 121, a basic data maintenance module 122, a tracking module 123, a querying module 124, an alerting module 125 and a path management module 126. The authorization control module 121 defines operational rights and a scope of access for each user of the automatic cargo tracking system. The data maintenance module 122 is used for adding, modifying, or deleting basic information. Said basic information comprises information on cargo, forwarders and shipping paths, export files, cargo tracking records, and abnormality records. The tracking module 123 is used for obtaining an arrival time and a departure time of an original port, information on a shipping path from the shipping path database 102, and information on cargo tracking and a proof of delivery from the client computers 16; for storing said obtained matters in cargo tracking records of the on way cargo database 103; and for determining whether to continue cargo tracking by accessing a corresponding cargo tracking record of the on way cargo database 103. The querying module 124 is used for querying cargo tracking records according to criteria such as shipping status, destination port, forwarder, original port, or pick up date; for obtaining results of each particular query; and for displaying the results of each query on the user interface 161 of a relevant client computer 16 via the output device 162. The alert module 125 is used for comparing an actual time with a corresponding estimated time in a cargo tracking record. When the actual time is later than the estimated time, the alert module 125 generates an alert message, stores the alert message in a corresponding abnormality record of the on way cargo database 103, and sends the alert message to the path management module 126. The path management module 126 is used for determining whether to switch a particular shipping path based on any alert message received from the alert module 125 and/or any abnormality message received from a client computer 16; for selecting a new optimal shipping path where appropriate; and for switching the shipping path to maintain the delivery date.

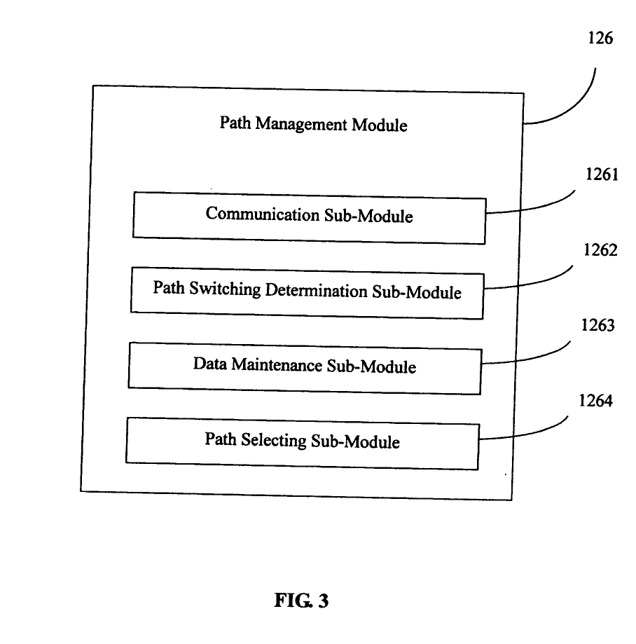

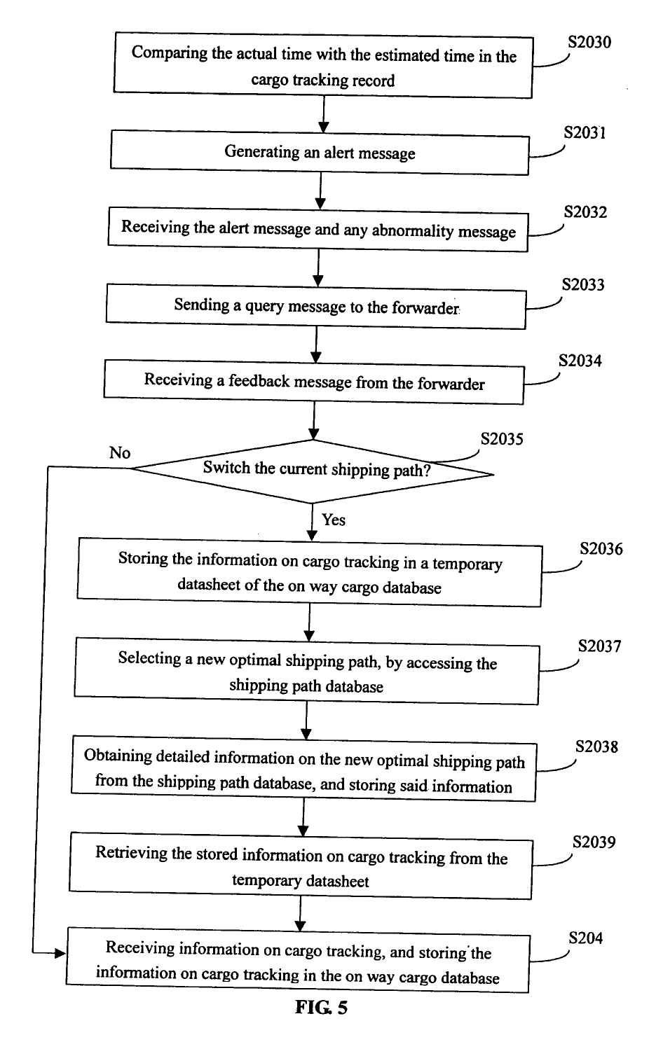

FIG. 3 is a schematic diagram of sub-modules of the path management module 126 of the application server 12. The path management module 126 comprises a communication sub-module 1261, a path switching determination sub-module 1262, a data maintenance sub-module 1263, and a path selecting sub-module 1264. The communication sub-module 1261 is used for communicating with the client computers 16 of forwarders and the alert module 125 of the application server 12. In particular, the communication sub-module 1261 receives alert messages from the alert module 125 and abnormality messages from the client computers 16, sends a query message to the client computer 16 of a relevant forwarder after receiving an alert message or an abnormality message, and receives a feedback message from said client computer 16. The query message queries whether the forwarder can maintain the delivery date or not. The feedback message may be “Yes” or “No.” The path switching determination sub-module 1262 is used for determining whether or not to switch a current shipping path based on a feedback message, and for switching the current shipping path when the feedback message is “No.” The data maintenance sub-module 1263 is used for storing information on cargo tracking in a temporary datasheet of the on way cargo database 103 before the path selecting sub-module 1264 selects a new optimal shipping path, for obtaining detailed information on the new shipping path by accessing the shipping path database 102, for storing said information in a corresponding cargo tracking record, and for retrieving the information on cargo tracking from the temporary datasheet. The path selecting sub-module 1264 is used for selecting a new optimal shipping path according to an estimated arrival time at a destination port, by accessing the shipping path database 102. The selection of the new optimal shipping path should follow two rules: first, the estimated arrival time for the destination port according to the new optimal shipping path is not later than that based on the original shipping path, in order to maintain the delivery date; and second, the original port, the destination port, the current port, and all ports that the cargo has passed through of the new optimal shipping path are identical to those of the original shipping path. Functions of the above-mentioned sub-modules 1261-1264 are further detailed in the following description relating to FIG. 5.

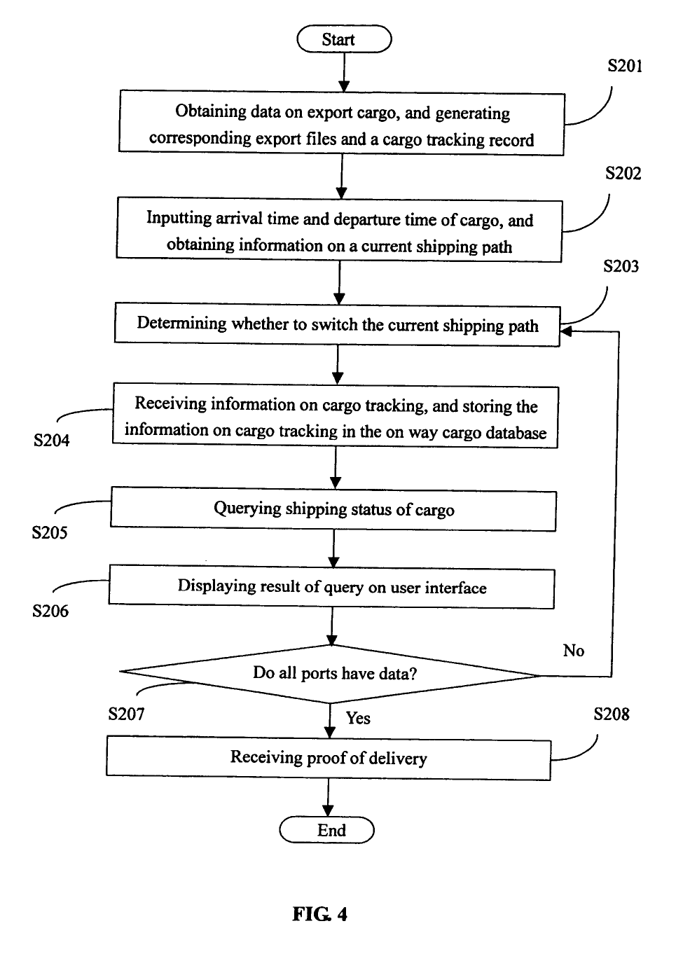

FIG. 4 is a flowchart of operation of the automatic cargo tracking system. In step S201, the basic data maintenance module 122 obtains data on export cargo by accessing the basic information database 101, generates corresponding export files and a cargo tracking record, stores the export files and the cargo tracking record in the on way cargo database 102, and sets the system status as “Not Started.” The data on export cargo comprises information on cargo, information on forwarders, and information on shipping paths. Once the cargo is ready at the original port, in step S202, an operator inputs an arrival time and a departure time of the original port via the tracking module 123, the basic data maintenance module 122 switches the system status to “In Process,” and the tracking module 123 obtains information on a current shipping path by accessing the shipping path database 102 and stores said information in the cargo tracking record of the on way cargo database 103. The original port may, for example, be the dispatch department of a manufacturer that makes the cargo. In step S203, the path management module 126 determines whether to switch the current shipping path based on any alert message(s) received from the alert module 125 and/or any abnormality messages received from the client computers 16, and switches the current shipping path if appropriate. In step S204, the tracking module 123 receives information on cargo tracking from relevant client computers 16, and stores the information on cargo tracking in the corresponding cargo tracking record of the on way cargo database 103. The information on cargo tracking comprises an actual arrival time and an actual departure time of each port that the cargo has passed through, the system status, the shipping status, and a current position of the cargo. In step S205, the querying module 124 queries cargo tracking records for the shipping status of the cargo, and obtains a result of the query. In step S206, the querying module 124 displays the result of the query on the user interface 161 of the corresponding client computer 16 via the output device 162. In step S207, the tracking module 123 determines whether to continue the cargo tracking by accessing the corresponding cargo tracking record of the on way cargo database 103. If all ports in the cargo tracking record have data, this means that cargo tracking is completed. In this case, the basic data maintenance module 122 switches the system status to “Delivered,” and the procedure proceeds to step S208. If one or more ports still do not have data, then cargo tracking is ongoing, and the procedure returns to step S203. When the cargo is received at the destination port, the destination recipient uploads a proof of delivery via the relevant client computer 16. In step S208, the tracking module 123 receives a proof of delivery, stores the proof of delivery in the cargo tracking record of the on way cargo database 103, and the basic data maintenance module 122 switches the system status to “Closed.”

FIG. 5 is a flowchart of details of step S203 of FIG. 4, namely determining whether to switch the current shipping path. In step S2030, the alert module 125 periodically accesses those cargo tracking records of the on way cargo database 103 which have system statuses that are “In Process,” and for the cargo in question compares an actual time with an estimated time of a current port in the relevant cargo tracking record. If the actual time is later than the estimated time, in step S2031, the alert module 125 generates an alert message, stores the alert message in an abnormality record of the on way cargo database 103, and sends the alert message to the communication sub-module 1261 of the path management module 126. In step S2032, the communication sub-module 1261 receives the alert message sent by the alert module 125. In addition, the communication sub-module 1261 may receive an abnormality message from the client computer 16 of a corresponding forwarder. If so, the communication sub-module 1261 stores the abnormality message in the abnormality record of the on way cargo database 103. In step S2033, the communication sub-module 1261 sends a query message to the client computer 16 of the corresponding forwarder. In step S2034, the communication sub-module 1261 receives a corresponding feedback message from the client computer 16 of the corresponding forwarder. In step S2035, the path switching determination sub-module 1262 of the path management module 126 determines whether to switch the current shipping path based on the feedback message. If the feedback message is “No,” the path switching determination sub-module 1262 determines to switch the current shipping path, and in step S2036, the data maintenance sub-module 1263 stores the information on cargo tracking in the temporary datasheet of the on way cargo database 103. In step S2037, the path selecting sub-module 1264 of the path management module 126 selects a new optimal shipping path according to an estimated arrival time at the destination port, by accessing the shipping path database 102. In step S2038, the data maintenance sub-module 1263 obtains detailed information on the new shipping path from the shipping path database 102, and stores said detailed information in the cargo tracking record. In step S2039, the data maintenance sub-module 1263 retrieves the stored information on the original cargo tracking from the temporary datasheet, and stores said information in the cargo tracking record, whereupon the procedure proceeds to step S204 as per FIG. 4. If the feedback message is “Yes,” then because the forwarder can deliver the cargo on time, the path switching determination sub-module 1262 determines to not switch the current shipping path, and the procedure proceeds directly to step S204.

In general, the automatic cargo tracking system and method of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention, which is defined by the claims appended hereto and allowable equivalents thereof.

What is claimed is:

1. An automatic cargo tracking system which enables switching of current shipping paths to avoid or reduce any delay in delivery of cargo, the system comprising:
a database server, comprising:
a shipping path database for storing information on shipping paths, the information on shipping paths comprising names of ports that a cargo passes through, a standard arrival time and an estimated arrival time for each of said ports, and a standard departure time and an estimated departure time for each of said ports; and
an on way cargo database for storing cargo tracking records, wherein the cargo tracking records comprises columns for: packing number, information on shipping path, actual arrival time for each of ports that a cargo passes through, actual departure time for each of said ports, system status, shipping status, current position, and proof of delivery;
a plurality of client computers; and
an application server linked to the client computers via a network, the application server comprising:
a tracking module for obtaining an arrival time and a departure time of an original port, information on a shipping path from the shipping path database, information on cargo tracking and a proof of delivery from a respective one of the client computers;
an alerting module for comparing an actual time with a corresponding estimated time in a cargo tracking record, and for generating an alert message when the actual time is later than the estimated time; and
a path management module for determining whether to switch a current shipping path based on any alert message, for selecting a new optimal shipping path, and for switching the shipping path to maintain a delivery date.

2. The system according to claim 1, wherein the database server further comprises a basic information database for storing information on cargo and information on forwarders.

3. The system according to claim 1, wherein the on way cargo database further comprises a temporary datasheet for temporarily storing information on cargo tracking.

4. The system according to claim 1, wherein the path management module comprises:
a communication sub-module for communicating with the client computers of forwarders and the alert module of the application server;
a path switching determination sub-module for determining whether to switch a current shipping path based on a feedback message, and for switching the shipping path if appropriate;
a data maintenance sub-module for storing information on cargo tracking in a temporary datasheet of the on way cargo database before selection of a new optimal shipping path, for obtaining detailed information on the new optimal shipping path by accessing the shipping path database, and for retrieving the information on cargo tracking from the temporary datasheet; and
a path selecting sub-module for selecting the new optimal shipping path according to an estimated arrival time of a destination port, by accessing the shipping path database.

5. The system according to claim 4, wherein the feedback massage is sent in response to a query message, which queries whether a forwarder can maintain the delivery date.

6. The system according to claim 5, wherein the feedback message may be “Yes” or “No,” and the path switching determination sub-module switches the current shipping path if the feedback message is “No.”

7. The system according to claim 1, wherein the selection of the new optimal shipping path follows two rules as follows: first, the estimated arrival time for the destination port according to the new optimal shipping path is not later than that based on the original shipping path, in order to maintain the delivery date; and second, the original port, the destination port, the current port, and all ports that the cargo has passed through of the new optimal shipping path are identical to those of the original shipping path.

8. The system according to claim 1, wherein the tracking module is further used for determining whether to continue the cargo tracking by accessing a corresponding cargo tracking record of the on way cargo database.

9. The system according to claim 1, wherein the application server further comprises a querying module for querying cargo tracking records according to criteria comprising shipping status, destination port, forwarder, original port, or pick up date; for obtaining results of each particular query; and for displaying the results of each query on a respective client computers.

10. The system according to claim 1, wherein the application server further comprises a basic data maintenance module for adding, modifying, or deleting basic information, wherein the basic information comprises information on cargo, forwarders and shipping paths, export files, cargo tracking records, and abnormality records.

11. The system according to claim 1, wherein the application server further comprises an authorization control module for defining operational rights and a scope of access for each user of the automatic cargo tracking system.

12. An automatic cargo tracking method which enables switching of a current shipping paths to avoid or reduce any delay in delivery of cargo, the method comprising the steps of:
(a) generating export files and a cargo tracking record;
(b) comparing an actual time with an estimated time of a current port in a particular cargo tracking record, and generating an alert message when the actual time is later than the estimated time;
(c) receiving the alert message, determining whether to switch a current shipping path, and switching the current shipping path if appropriate;
(d) receiving information on cargo tracking from one or more client computers of one or more corresponding forwarders, and storing the information on cargo tracking in the cargo tracking record; and
(e) determining whether to continue the cargo tracking by accessing the cargo tracking record, and receiving a proof of delivery if all of ports in the cargo tracking record have data.

13. The method according to claim 12, wherein step (a) further comprises the steps of:
(a1) obtaining data on export cargo by accessing a basic information database, wherein the data on export cargo comprises information on cargo, information on forwarders, and information on shipping paths;
(a2) storing the export files and the cargo tracking record in an on way cargo database;
(a3) obtaining an arrival time and a departure time of an original port, and information on the current shipping path; and
(a4) storing said obtained matters in the cargo tracking record.

14. The method according to claim 12, wherein step (c) further comprises the steps of:
(c1) receiving an abnormality message from the client computer of one corresponding forwarder;
(c2) storing the alert message and/or the abnormality message in an abnormality record of an on way cargo database;
(c3) sending a query message to the client computer of said corresponding forwarder;
(c4) receiving a corresponding feedback message from the client computer of said corresponding forwarder; and
(c5) determining whether to switch the current shipping path based on the feedback message, and switching the current shipping path if the feedback message indicates inability to deliver on time.

15. The method according to claim 12, wherein step (b) further comprises the steps of:
(b1) obtaining the actual time and the estimated time of the current port in the cargo tracking record by periodically accessing the cargo tracking record; and
(b2) sending the alert message.

16. The method according to claim 14, wherein switching the current shipping path in step (c5) further comprises the step of:
(i) storing the information on cargo tracking in a temporary datasheet of the on way cargo database;
(ii) selecting a new optimal shipping path according to an estimated arrival time of a destination port, by accessing the shipping path database;
(iii) obtaining detailed information on the new optimal shipping path by accessing the shipping path database, and storing said information in the cargo tracking record; and
(iv) retrieving the information on cargo tracking from the temporary datasheet.

17. The method according to claim 16, wherein the selection of the new optimal shipping path follows two rules as follows: first, the estimated arrival time for the destination port according to the new optimal shipping path is not later than that based on the original shipping path, in order to maintain the delivery date; and second, the original port, the destination port, the current port, and all ports that the cargo has passed through the new optimal shipping path are identical to those of the original shipping path.

18. The method according to claim 12, wherein step (e) further comprises the step of:
(e1) returning to step (d) if one or more of the ports in the cargo tracking record still do not have data.

19. An automatic cargo tracking method which enables switching of current shipping paths to avoid or reduce any delays in delivery of cargo, comprising steps of:
(a) setting an initial shipping path and setting estimated arrival time at each of ports on said initial shipping path;
(b) comparing an actual time with an estimate of a current port for a specific cargo tracking record;
(c) generating an alert message if the actual time is longer than the estimated time;
(d) determining whether a current shipping path should be revised to make up any delay if there is the alert message;
(e) setting another estimated arrival time at each of the corresponding ports on a revised shipping path; and
(f) repeating steps of (b) through (e) until the shipped cargo arrives a destined port.
